(19) United States
(12) Patent Application Publication
(10) Pub. No.: US 2015/0354271 A1
(43) Pub. Date: Dec. 10, 2015

(54) CONTROL DEVICE FOR CONTROLLING SLAT BLINDS UP AND DOWN

(71) Applicant: CHING FENG HOME FASHIONS CO., LTD, Fuxing Shiang (TW)

(72) Inventors: SHENG-YING HSU, Fuxing Shiang (TW); CHUN JAN HSU, Fuxing Shiang (TW)

(21) Appl. No.: 14/724,800

(22) Filed: May 28, 2015

(30) Foreign Application Priority Data
Jun. 10, 2014 (TW) 103210162

(51) Int. Cl. E06B 9/322; E06B 9/323

(52) U.S. Cl. CPC E06B 9/322; E06B 9/323

(57) ABSTRACT

A control device for controlling blinds up and down includes a case and a shaft is rotatably located in the case. A coil spring is located in a reception box in the case and has a connection end which extends through the wall of the reception box and is connected to a mandrel. The shaft securely extends through a passage of the mandrel which is co-rotatable with the shaft. A cover is mounted to the case and a gear unit is located on the cover. The gear unit includes a first bevel gear and a second bevel gear which is engaged with the first bevel gear which drives the second bevel gear. The second bevel gear is connected to the mandrel which is co-rotatable with the second bevel gear. The coil spring is wrapped to the mandrel and retrieved in the reception box when the blinds are lowered and lifted.

### BACKGROUND OF THE INVENTION

1. Fields of the Invention

The present invention is a Continuation-In-Part application of applicant's prior U.S. Pat. No. 7,866,367, filed on Jan. 31, 2008.

2. Descriptions of Related Art

The conventional control device for controlling the blinds to be lifted up or lowered down is installed in the head box, and a blinds rotation device is also installed in the head box so as to adjust the angular position of each of the blinds. Applicant disclosed a control device for a slat blinds and disclosed in U.S. Pat. No. 7,866,367, filed on Jan. 31, 2008, which comprises a transmission unit and a scrolling unit. The transmission unit comprises case, a coil spring and a gear set. The coil spring has one end connected to the gear set and the other end of the coil spring is fixed to the case. The scrolling unit has two posts and a driven member. The posts are connected with the cords which extend through the slats. The driven member has a gear fixing unit connected to the mediate portion thereof. The two posts are connected to two ends of the driven member. A separation board is adjusted left and right by the first slot and the second slot. The separation board has an adjustment slot which is engaged with the engaging slot or engaging plate of the case to that the gears can be optionally chosen to be cooperated with the weight of the blinds.

The present invention intends to provide a control device for controlling the blinds and the gear unit is simplified so as to reduce the manufacturing cost and the weight.

### SUMMARY OF THE INVENTION

The present invention relates to a control device for controlling blinds up and down, and comprises a case having a shaft rotatably located therein. A cover is mounted to the case and has a through hole. A coil spring is located in a reception box which is located in the case and beside the shaft. The coil spring has a connection end which extends through a wall of the reception box and connected to a mandrel. The mandrel has a passage defined axially therethrough and the shaft is securely connected to the passage. A gear unit is located on the top of the cover and comprises a first bevel gear and a second bevel gear which is orthogonally engaged with the first bevel gear which drives the second bevel gear. The second bevel gear is axially connected to the mandrel which is co-rotatable with the second bevel gear. The coil spring is wrapped to the mandrel and retrieved in the reception box when the blinds are lowered and lifted.

The primary object of the present invention is to provide a control device for controlling blinds up and down, wherein the gear unit of the present invention is simplified and only comprises a first bevel gear and the second bevel gear. The simplified structure of the present invention reduces the manufacturing cost and the assembling time.

Another object of the present invention is to provide a control device for controlling blinds up and down, wherein the simplified gear unit of the present invention reduces the weight of the blinds.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the control device of the present invention installed to the head box of the blinds;

FIG. 2 is an exploded view of the control device of the present invention;

FIG. 3 is a perspective view to show the control device of the present invention;

FIG. 4 is a side view of the control device of the present invention, and

FIG. 5 is a perspective view to show another embodiment of the control device of the present invention installed to the head box of the blinds.

### DETAILED DESCRIPTION OF THE PREFERRED EMBODIMENT

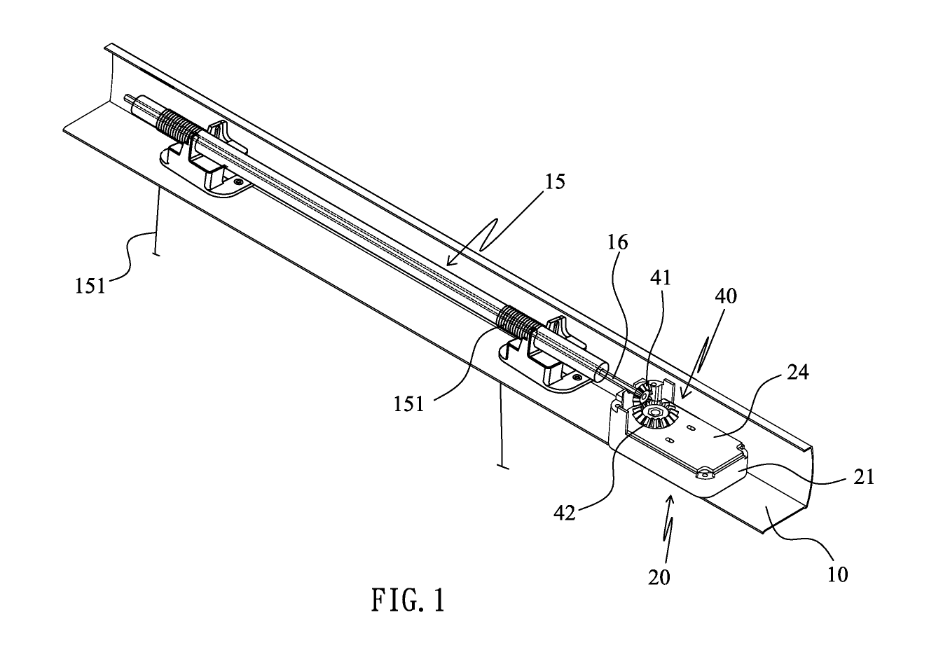

Referring to FIG. 1 showing the blinds that comprises a head box 10 in which two scrolling shafts 15 and the control device 20 of the present invention are installed. The scrolling shafts 15 each have a cord 151 scrolled thereto which extends through the blinds (not shown). A transmission shaft 16 that has a non-circular cross section is connected between the scrolling shafts 15 and the control device 20 of the present invention so that the force from the control device 20 drives the scrolling shafts 15 via the transmission shaft 16, such that the scrolling shafts 15 are rotated to operate the cards 151 to lower or raise the blinds.

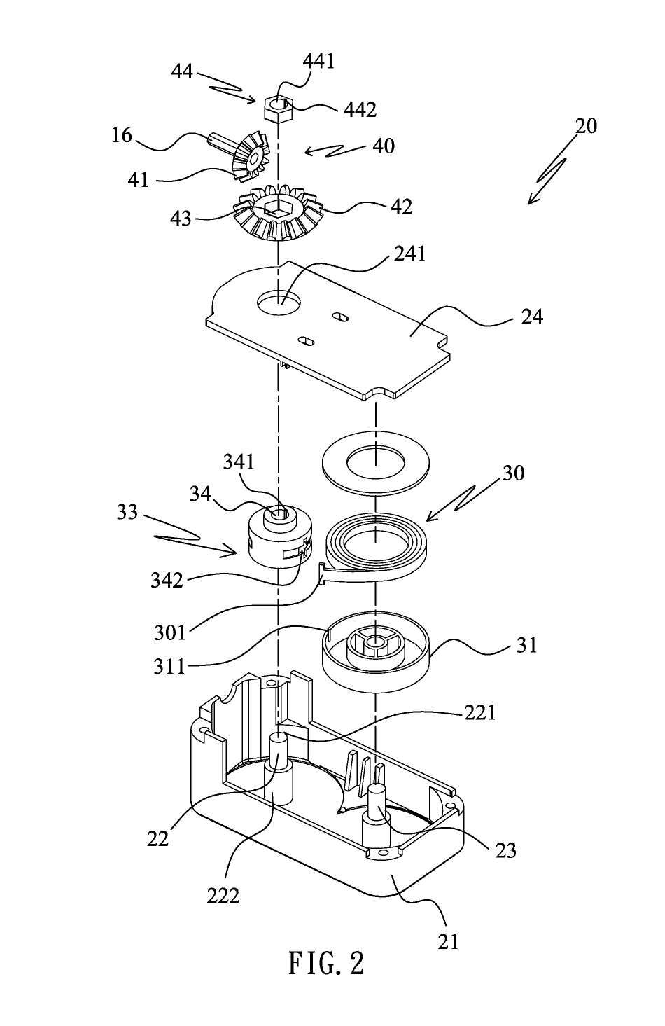

As shown in FIGS. 2 to 4, the control device 20 of the present invention comprises a gear unit 40, a case 21, a coil spring 30, a reception box 31 that receives the coil spring 30, and a mandrel 33. The case 21 has a shaft 22 rotatably located therein, and a fixing post 23 is located at a distance from the shaft 22. A key 221 extends outward and axially from the outside of a first section of the shaft 22, and a second section of the shaft 22 is rotatably inserted into a base 222 in the case 21. A cover 24 is mounted to the case 21 and has a through hole 241.

The coil spring 30 is located in the reception box 31 which is located in the case 21 and beside the shaft 22. The reception box 31 is mounted to the fixing post 23. The reception box 31 has a notch 311 defined in the wall thereof, the coil spring 30 extends through the notch 311 and has a connection end 301 which is securely engaged with a connection hole 342 of the mandrel 33. The mandrel 33 has a passage 34 defined axially therethrough and the shaft 22 is securely connected to the passage 34. The mandrel 33 has a keyway 341 defined in the inside of the passage 34. The shaft 22 is inserted into the passage 34 and the key 221 of the shaft 22 is engaged with the keyway 341.

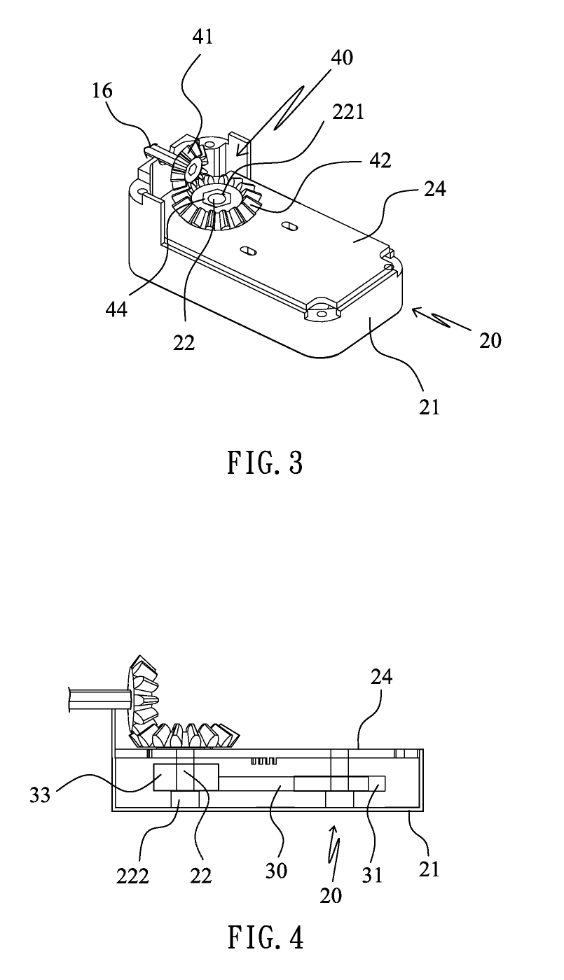

The gear unit 40 is located on the top of the cover 21 and has a first bevel gear 41 and a second bevel gear 42 which is orthogonally engaged with the first bevel gear 41 which drives the second bevel gear 42. The second bevel gear 42 of the gear unit 40 has a polygonal hole 43 defined axially therethrough, and a nut 44 is securely located in the polygonal hole 43 and has a central hole 441. A keyway 442 is defined in the inside of the central hole 441, the key 221 is engaged with the keyway 442 so as to position the second bevel gear 42 on the cover 24. The top end of the mandrel 33 extends beyond the cover 24 via the through hole 241, the first bevel gear 41 is mounted to the top end of the mandrel 33. The key 221 of the shaft 22 is engaged with the two respective keyways 341, 441, so that the second bevel gear 42 together with the nut 44 and the shaft 22 are rotatable relative to the base 222. As shown in FIGS. 3 and 4, the gear unit 40 of the present invention is simplified to include only the first and second bevel gears 41, 42.

As shown in FIGS. 1 to 3, when the blinds are lowered to a position, the user operates the bottom bar (not shown) located at the lowest end of the blinds, the cords 151 are lowered and the rotates the scrolling shafts 15 and the transmission shaft 16, such that the first bevel gear 41 is rotated and drives the second bevel gear 42. The second bevel gear 42 drives the mandrel 33 which is rotated relative to the base 222, so that the coil spring 30 is then scrolled to the mandrel 33, and a balance between the weight of the blinds and the force of the coil spring 30.

When the user pushes the bottom bar upward, the cords 151 are lifted and rotates the scrolling shafts 15 and the transmission shaft 16, such that the first bevel gear 41 is rotated and drives the second bevel gear 42. The mandrel 33 is rotated relative to the base 222, so that the coil spring 30 is then retrieved into the reception box 31, and the blinds are lifted.

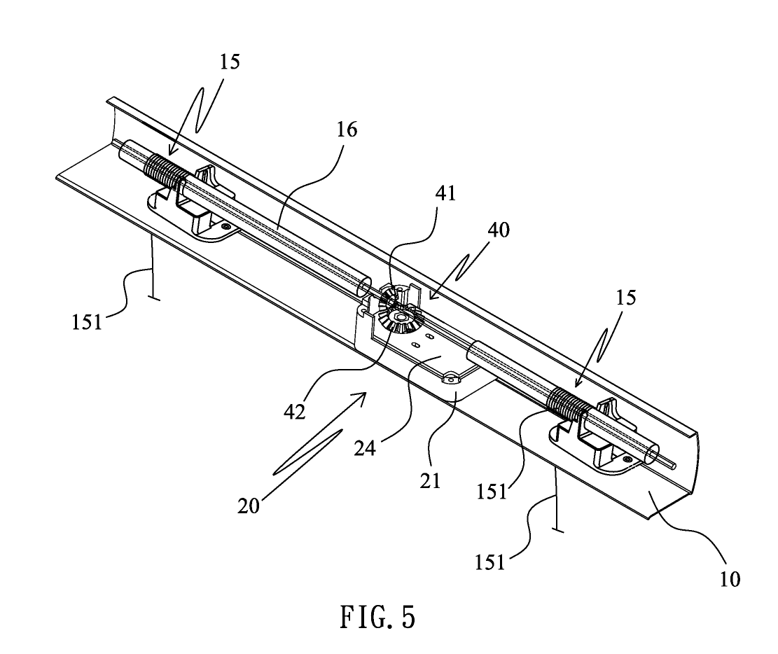

As shown in FIGS. 1 and 5, the control device 20 of the present invention can be installed to one side of the two scrolling shafts 15 or located between the two scrolling shafts 15. Both arrangements can achieve the desired purposes.

While we have shown and described the embodiment in accordance with the present invention, it should be clear to those skilled in the art that further embodiments may be made without departing from the scope of the present invention.

What is claimed is:

1. A control device for controlling blinds up and down, comprising:
a case having a shaft rotatably located therein, a cover mounted to the case and having a through hole;
a coil spring located in a reception box which is located in the case and beside the shaft, the coil spring having a connection end which extends through a wall of the reception box and connected to a mandrel, the mandrel having a passage defined axially therethrough and the shaft securely connected to the passage, and
a gear unit located on a top of the cover and having a first bevel gear and a second bevel gear which is orthogonally engaged with the first bevel gear which drives the second bevel gear, the second bevel gear axially connected to the mandrel which is co-rotatable with the second bevel gear.

2. The device as claimed in claim 1, wherein a fixing post is located in the case and beside the shaft, the reception box is mounted to the fixing post and positioned in the case.

3. The device as claimed in claim 1, wherein a key extends outward and axially from an outside of a first section of the shaft, a second section of the shaft is rotatably inserted into a base in the case, the mandrel extends through the through hole of the cover.

4. The device as claimed in claim 1, wherein the reception box has a notch defined in the wall thereof, the coil spring extends through the notch, the connection end of the coil spring is securely engaged with a connection hole of the mandrel.

5. The device as claimed in claim 1, wherein a key extends outward and axially from an outside of a first section of the shaft, the mandrel has a keyway defined in an inside of the passage, the shaft is inserted into the passage and the key is engaged with the keyway of the mandrel.

6. The device as claimed in claim 1, wherein the second bevel gear of the gear unit has a polygonal hole defined axially therethrough, a nut is securely located in the polygonal hole and has a central hole, a keyway is defined in the inside of the central hole, the key is engaged with the keyway of the nut so as to position the second bevel gear on the cover.
